(19) United States
(12) Patent Application Publication
(10) Pub. No.: US 2023/0205761 A1
(43) Pub. Date: Jun. 29, 2023

(54) METHOD OF CREATING A DISTRIBUTED LEDGER FOR A BLOCKCHAIN VIA ENCAPSULATION OF OFF-CHAIN DATA

(71) Applicant: ENCAPSA TECHNOLOGY LLC, Herndon, VA (US)

(72) Inventor: CHRISTOPHER B. A. COKER, ANNANDALE, VA (US)

(73) Assignee: ENCAPSA TECHNOLOGY LLC, HERNDON, VA (US)

(21) Appl. No.: 17/992,678

(22) Filed: Nov. 22, 2022

Related U.S. Application Data
(63) Continuation-in-part of application No. 16/943,645, filed on Jul. 30, 2020, now Pat. No. 11,507,556.

(51) Int. Cl. G06F 16/23; H04L 9/00

(52) U.S. Cl. CPC G06F 16/2379; H04L 9/50

(57) ABSTRACT

An example computer-implemented method is described which creates a distributed ledger for a blockchain via encapsulation of off-chain data. The off-chain data may be data records with different structured and unstructured formats, and are ingested from multiple different and disparate data storage locations external to the blockchain. The method includes creating, via encapsulation, a plurality of field-value pairs representative of the given external data record of off-chain data. The plurality of field-value pairs are created dynamically without regard to the underlying data structure of the given external data record of off-chain data. The created plurality of field-value pairs are then added as blockchain transactions to a body portion of each of one or more blocks across the blockchain. These created field-value pairs represent a distributed ledger by which data can be added as blockchain transactions across all blocks of the blockchain.

### CROSS-REFERENCE TO RELATED APPLICATIONS

The present application is a continuation-in-part of, and claims the benefit under 35 U.S.C. § 120 to U.S. patent application Ser. No. 16/943,645 (the '645 application) by the inventor, filed Jul. 30, 2020, pending. The entire contents of the '645 application is hereby incorporated by reference herein.

### BACKGROUND

### Field

Example embodiments in general relate to a computer-implemented method adapted to create a distributed ledger for a blockchain via encapsulation of off-chain data.

### Related Art

Blockchain is a decentralized, distributed and public digital ledger. At its most basic, blockchain refers to peer-to-peer distributed ledger technology adapted to record secure digital records of transactions between two parties efficiently and in a verifiable and permanent way, enabling tracking and traceability. The decentralized nature of blockchain ensures that there is no single central entity governing data-related decisions.

To understand a key basis of blockchain, it is instructive to understand where the phrase “distributed ledger” came from. Originally, the conventional general ledger or “ledger” was defined as a centralized paper-based (prior to the information age) record-keeping system for financial data, such as a spreadsheet (a data record in itself) and later included other off-the-shelf financial tracking systems (i.e., QUICKBOOKS®, ERPs) used by individuals, families, companies, organizations and the like for tracking assets and liabilities (information to create the ledger being recorded transactions such as credits and debits). Also known as a principal book of accounts and this data record could be composed of multiple general ledger accounts.

Ledgers of this conventional type are thus most commonly found in business (like a sales ledger, debtor ledger, or creditors ledger), but the concept can apply to anything. All data records such as bank accounts, credit cards, assets, and liabilities can be compiled into a general ledger, a one-stop, centralized point of access, recording information about financial transactions to be easily readable and searchable.

These conventional ledgers of yesteryear had many faults and vulnerabilities, the most obvious being that only one centralized ledger existed and could be lost, stolen, destroyed, hacked or manipulated in some way. Further, the conventional general ledger was also prone to fraud or simply human error. Even though today many larger enterprises now use elaborate ERP (enterprise resource planning) solutions to manage everything from ledgers and inventory to orders, payroll, and even customer relations, the margin for error still exists with these 21st-century software-based tools.

The key concept to understanding a distributed ledger is decentralization, which differs from the ledgers of old that were entirely centralized and controlled by an administrator. With distributed ledgers, there isn't one person in charge of accounts receivable and other accounting records. Rather, everything relies on consensus, replication and data synchronization across data. records within an entire digital database. This ensures the accuracy of transaction data throughout the entire system.

In other words, a change to records in a database by a user in Geneva, Switzerland would have to be synchronized across every node from Washington, DC to Hong Kong at a high-speed rate. Thus, the concept of a distributed ledger builds on the foundations of a general ledger and the many subcategories in accounting, and is where one comes to the intersection of blockchain and cryptocurrency as relates to all the fascinating developments in tech and finance happening today.

The original blockchain concept appeared in 1991 from Stuart Haber and W. Scott Stornett, considered the founding fathers of blockchain technology. The first mention of blockchain architecture was mentioned in a publication that Stornett co-authored which described a digital hierarchy system known as a “block chain” that used digital time-stamps for ordering transactions. Together, Haber and Stornett presented their idea of a cryptographically-secure chain of records or blocks.

In 2008, “Satoshi Nakamoto” developed an established model and scope for the technology, a turning point. Satoshi Nakamoto was the name used by the presumed pseudonymous person(s) who developed bitcoin, authored the Bitcoin white paper, and who created and deployed Bitcoin's original reference implementation. As part of the implementation, Nakamoto also devised the first blockchain database. Nakamoto was active in the development of Bitcoin up until December 2010. The Bitcoin blockchain became the start of blockchain's evolution.

In 2013, Russian-Canadian developer Vitalik Buterin published a white paper describing a platform that combined traditional blockchain functionality with a noted difference, the incorporation of computer code execution. This signified the birth of the Ethereum blockchain. From the very beginning, Ethereum was positioned as a base for integrating blockchain technologies into third-party projects. Currently, an Ethereum blockchain enables developers to create complex programs able to interact with one other through the blockchain itself.

Since the introduction of non-functional tokens (NFTs), cryptocurrencies such as bitcoin, and the Ethereum blockchain, a myriad applications have blossomed. Namely, this emerging technology is beginning to show game changing potential for a broad range of applications that go far beyond its roots in cryptocurrency.

For example, pharmaceutical companies have now developed blockchain applications to secure supply chains for medicine and confidential test data. Additionally, in collaboration with IBM®, WALMART® developed a blockchain system that reduced product tracing times from seven (7) days to 2.2 seconds. In addition to healthcare, supply chain, and retail, additional blockchain applications have already or are being developed in the energy, education, cybersecurity, agriculture, and media/arts & entertainment sectors.

Moreover, blockchain is now disrupting the banking industry, according to technology analysis firm CB Insights. Namely, this is because blockchain's decentralized, peer-to-peer platform has changed the way people raise and transfer money. As a result, global banking institutions are transitioning to blockchain technology to manage payments and loans, administer smart contracts and sell crypto assets. For example, BANK OF AMERICA® (BOA) is getting into digital assets, which at this writing represents a $2 trillion global market. BOA also offers a global payments platform based on blockchain. Additionally, JP MORGAN CHASE® has created the blockchain-based platform ONYX™, which provides access to new payment methods, a digital coin, and the ability to trade other digital assets. Further, financial heavyweights such as BLACKROCK®, BNY MELLON®, FIDELITY® and APOLLO® also offer relevant bitcoin and crypto services.

The value adds of blockchain technology to commerce lie in its ability to reduce security risk, eradicate fraudulent schemes, and provide transparency. In operation, blockchain uses a Proof of Work consensus algorithm that consists of three key aspects: blocks, nodes, and miners. We now look at each of these.

Each individual chain consists of several blocks. Each block has a block header and a body portion. The block header includes a hash of the previous block field, a version field, a difficulty field, a timestamp, a nonce value field, and a Merkle tree root. The hash of the previous block is every block, since every block header gives information about the previous or parent block. This 32-byte field contains the hash value of the previous block and this reference connects all the blocks. The 4-byte version field stores the version number to show software upgrades. The mining difficulty at the time of the block creation is stored in the 4-byte difficulty field. The 4-byte timestamp field contains the time at which the block was created.

The nonce field contains a random whole number used during the mining of the block and having a 32-bit (4 byte) field, which is adjusted by the “miners” (discussed below), so that it becomes a valid number to be used for hashing the value of block. Nonce is the number which can be used only once. Once the perfect Nonce is found, it is added to the hashed block (generates the accepted hash). At that point, the data in a block is considered signed and forever linked to a nonce and hash, unless the block is mined.

The block header also includes a Merkle root (also known as a “root hash”). Use of a Merkle root makes it possible to securely verify that a transaction has been accepted by the blockchain network (and enables obtaining the number of confirmations) by downloading just the small block headers and Merkle tree, rather than having to download the entire block chain, which is unnecessary.

More specifically, every transaction has a hash associated with it. In a block, all of the transaction hashes therein are themselves hashed together (their transaction IDs or TXIDs). Sometimes this is done several times (the exact process is complex), and the result is the Merkle root. In other words, the Merkle root is the hash of all the hashes of all the transactions in the block.

Accordingly, a Merkle root can be thought of as a fingerprint for all the transactions in a block. The hashing together of all the pairs of TXIDs provides a short yet unique fingerprint for all the transactions in a block. Since the Merkle root is a field in a block header, this means that every block header will have a short representation of every transaction inside the block.

The block further is composed of a body section. The body section contains a series of inked or accepted transactions. Each block contain contains a different number of transactions that are to be added to the distributed ledger. The number of transactions is limited by the block size and gas limit. Generally, a block contains more than 500 transactions.

The composition of each block having a number of these immutable but dynamic “data” elements is what forms the bedrock of blockchain technology. Moreover, it is the ability to create millions of these blocks in real time (dynamically) that makes this technology possible.

The miners above can be understood as users who create new blocks in the chain through a mining process. Generally, miners use special software to solve a typically difficult mathematical problem of finding the unique one-time number that generates the accepted hash. A goal for miners is to receive a financial reward after a new block is successfully mined, and the change is accepted by all network nodes.

Decentralization is a central concept in blockchain technology. No organization or computer can be the owner of the network, as everything is implemented in the form of a distributed registry through nodes connected to the chain. Blockchain nodes can be understood as any electronic device that stores copies of chains and ensures operation of the network. Redundancy is inherent; should one or more computers (nodes) fail, the information will not be lost. Each node has its own copy of the blockchain, and each new block mined must be algorithmically approved by the network so that the chain is verified and updated. Accordingly, the decentralized nature of blockchain ensures that there is no single central entity governing data-related decisions.

One of the essential attributes of blockchain technology is the dispersion of data among distributed and transparent ledgers instead of centralized, permissioned databases characteristic of Web2 architectures. By disseminating transactional records globally, blockchains have changed how people think about data ownership, access, and storage. But this design is not without limitations. When data is duplicated across nodes, it creates a storage headache, which worsens as networks grow. This, in turn, leads to problems with scalability, performance, and availability.

The issue of storage is one of the most commonly discussed challenges facing blockchains today. All blockchain transactions are recorded and preserved on the network's ledger. As more transactions are executed on the network, more data is created, necessitating an increase in storage capacity. Moreover, blockchains are immutable, meaning that storage requirements constantly grow because nothing is ever deleted from the ledger.

Blockchain data is hosted on globally distributed machines referred to as nodes. Nodes essentially run software to validate and store information about the network's state. There are various types of nodes serving different functions. Some may retain a full copy of the ledger, while others store only the most recent blocks.

Although this architecture may vary from one network to another, a full node typically stores the entire network state, which is a complete history of transactions executed on the blockchain. Running a network node requires meeting some minimum hardware requirements. In the case of Bitcoin, among other requirements, a device must have at least 500 GB of free storage space with a minimum read/write speed of 100 MB/s to run a node.

As Ethereum co-founder Vitalik Buterin has argued, storage limitations impose a severe constraint on blockchain scalability. In an ideal scenario, considerably more users on blockchain networks would run their own nodes, but this would require significant hardware and bandwidth resources (a minimum of 1 TB of SSD storage is needed to run Eth 2.0 full nodes). The costs associated with this significant hardware and bandwidth are prohibitively high for the average user. For example, a quick recent look at Etherscan showed an average of fewer than 10,000 nodes running on the Ethereum network over a 30 day period. This has raised questions about the computational limits for blockchains and just how decentralized networks might be enhanced in the future.

In general, there are two different ways to store data in a blockchain, on-chain storage and off-chain storage. On-chain storage is an extremely costly method of storing the data in the blockchain as the data is stored inside each block on the chain. If an attack happens, then data can be restored and used. As the block is limited as to how much data can be stored on it, and due to the prohibitive cost, most entities find this method unattractive. With off-chain storage, only the metadata is stored in the chain. The entire data record is not stored in the chain, so if any attack happens then it might not be possible to restore the data record. As compared to on-chain storage, off-chain storage is a more cost-efficient method of data storage.

Accordingly, blockchains by design are not ideal for storing large amounts of data. Instead, when a transaction is logged onto a blockchain—say, a record of purchase—that event is logged across nodes. That's “on-chain” data stored in the aforementioned on-chain storage. Any other data related to that transaction—for example, an image of the purchase, a description, etc.—is stored elsewhere. That's “off-chain” data stored in the aforementioned off-chain storage.

Cloud storage is the traditional way of storing data on a blockchain. The biggest disadvantage of cloud storage is that all data is centralized and is not usually encrypted during transactions. Data is the most critical entity, storing, processing, and analyzing data is a significant job. Thus, there is a requirement for decentralized storage. Decentralized cloud storages allow for the storage of static data where data is not stored on the company server, but instead on devices of the renters. This storage can be used online, thus making transactions fast and efficient. But decentralized storage solutions are also costly.

Several solutions have been developed in an effort to address the blockchain storage problem. One is the use of sharding. Sharding is an optimization technique that entails partitioning the blockchain workload into various shards, with dedicated nodes focusing on unique data types. This frees up other nodes to take on more computational tasks, optimally so as to reduce the amount of storage space each node must allocate for the distributed ledger.

A benefit of sharding is that it increases on-chain storage capacity without relying on third parties. This means that storage capacity does not come at the expense of decentralization, and at the same time, the network's attack surface is not increased. However, a downside of sharding as used today is that sharding remains limited as to the extent to which it can remedy the storage problem.

Another approach to improving on-chain storage is by locally removing older or less relevant information from a specific node category. This is known as pruning. By eliminating older transactional data, storage can be freed up, enabling more people to run nodes without meeting stringent hardware requirements. However, pruning carries certain risks. For instance, if an attacker targeted an older block that had been pruned, the entire network could be compromised.

There are a few workarounds to the blockchain data storage problem. The first is oracle networks. Sometimes, an encrypted hash can direct users to off-chain storage where data is logged. The connection between the two happens via a decentralized oracle network. CHAINLINK® is a decentralized third-party technology that connects blockchain ledgers to the real world and to data storage. These provide the connective tissue, all while remaining decentralized.

But this data storage cannot be just any storage, especially as blockchain applications scale. To uphold the promise of blockchain's speed and efficiency, storage has to be fast, incredibly scalable, and able to consolidate significantly disparate and diverse types of data. Accordingly, serious limitations with on-chain storage exist today, which could significantly impact network performance. As transactional data grows, so too does necessary storage needs.

Particularly, unstructured, off-chain data is going to accumulate exponentially. As such, better data storage platforms must be embedded into new blockchain applications. JaxEnter.com noted “Blockchain won't be able to disrupt any real-world industry unless the problem of data storage is resolved.” Accordingly, for blockchain applications to meet their SLAs, off-chain data storage will need to be powerful, elastic, and scalable.

### SUMMARY

An example embodiment of the present invention is directed to a computer-implemented method that creates a distributed ledger for a blockchain via encapsulation of off-chain data. The off-chain data may be data records with different structured and unstructured formats, and are ingested from multiple different and disparate data storage locations external to the blockchain. The method includes creating, via encapsulation, a plurality of field-value pairs representative of the given external data record of off-chain data. The plurality of field-value pairs are created dynamically without regard to the underlying data structure of the given external data record of off-chain data. The created plurality of field-value pairs are then added as blockchain transactions to a body portion of each of one or more blocks across the blockchain. These created field-value pairs represent a distributed ledger by which data can be added as blockchain transactions across all blocks of the blockchain.

### BRIEF DESCRIPTION OF THE DRAWINGS

Example embodiments will become more fully understood from the detailed description given herein below and the accompanying drawing, wherein like elements are represented by like reference numerals, which are given by way of illustration only and thus are not limitative of the example embodiments herein.

FIG. 1 is a simple diagram highlighting the essence of encapsulation.

FIG. 2 is a flow diagram to describe a method of encapsulating digital data records according to the example embodiments.

FIG. 3 is a block diagram to further describe the functionality of objects in accordance with the example embodiments.

FIG. 4 is a block diagram to highlight the interaction between ingestible digital data in the presentation layer and the objects that create DSCs in the data layer, in accordance with the example embodiments.

FIG. 5 is a simplified block diagram of a specific computer system for implementing the method of encapsulation.

FIG. 6A is a simplified block diagram to illustrate in general a method for creating a ledger dynamically in a blockchain network according to the example embodiments.

FIG. 6B is a block diagram similar to FIG. 6A, but for a different patient having different information and fields in their patient EDR.

FIG. 7 is a simplified block diagram to illustrate a generic blockchain network environment according to the example embodiments.

FIG. 8 is a simplified block diagram to illustrate a generic user device according to the example embodiments.

FIG. 9 is a simplified block diagram to illustrate a generic computer system to power the blockchain within the generic blockchain network environment of FIG. 7 according to the example embodiments.

FIG. 10 is a simplified high level block diagram to illustrate a generic centralized database architecture environment for the network of FIG. 7, according to the example embodiments.

FIG. 11 is a simplified high level block diagram to illustrate a generic blockchain system environment architecture of the system in FIG. 9, according to the example embodiments.

### DETAILED DESCRIPTION

The following describes a method of creating a distributed ledger for a blockchain via encapsulation of off-chain data. To understand the significance of encapsulation as applied to the blockchain is to understand what is to be replaced or modified. Namely, Applicant is specifically looking at the structure of the blockchain itself, and more specifically to the nature of the distributed ledger to which a collection of digital stem cells (DSCs, also known as data-pointer or field-value pairs) created by Applicant's method of encapsulation is trying to replace.

As will be appreciated by one skilled in the art, the example embodiments of the present invention may be embodied as a computing system, computing device, computer-implemented method, set of machine-readable instructions and associated data in a manner more persistent than a signal in transit, non-transitory computer-readable media, and/or as a computer program product or downloadable mobile app product for a mobile device. Accordingly, aspects of the example embodiments may take the form of an entirely hardware embodiment, an entirely software embodiment (including firmware, resident software, micro-code, etc.) or an embodiment combining software and hardware aspects that may all generally be referred to herein as a “circuit,” “module”, or “system.” Furthermore, aspects of the example embodiments may take the form of a computer program product embodied in one or more computer-readable medium(s) having computer-readable program code/instructions embodied thereon.

As used herein, the term “data” is defined as a unique segment of information which joins to other segments of information (“digital data”) to form a meaningful and recognizable knowledge stream. In the context of the example embodiments described hereafter, the data to be ingested from disparate storage locations is generically referred to as a “data record” or “data records” collectively, and/or occasionally as digital data.

However, it should be understood that the various types of digital data or information ingested from disparate data stores (such as databases, server stores, and the like) include but are not limited to, by example, the aforementioned data records (and/or tables or other tabular data in various formats), input forms such as a web forms, images such as pdf or jpeg files with associated metadata, etc., video/movie/streaming files in various file formats, audio files in various formats, other editable files and/or documents in various formats (e.g., formats such as those associated with any of a word processing file, any data or database file, spreadsheet file, compressed file, disc and media file, executable file, font file, internet-related file, presentation file, programming file, system-related file, and the like), text messages, electronic mail messages, files or records associated with social media-related postings, and also includes any document or file structure or type containing data which has not heretofore been developed but which may be created, developed, envisaged, or anticipated in the future.

As used herein a “storage location” (in its singular or plural) by example includes but is not limited to databases (e.g., relational, object-oriented, key-value), data stores such as distributed or open source data stores, simple files such as spreadsheets, email storage systems (client and server), and the like. A storage location also may be envisaged in a broader sense within a class of storage systems that include file systems, directory services for networks, and files that store virtual machines such as a VMware data store. Further, a storage location herein includes and pool, container, or other storage system which has not heretofore been developed but which may be created, developed, envisaged, or anticipated in the future. For the purposes of simplicity and convenience only hereafter, a storage location from which a data record is to be ingested for encapsulation shall be referred to primarily as a database

As used herein, the term “tuple” may be defined as a finite function that maps each fieldname field in a data record (hereafter “Fieldname”) to a certain data field or a certain value in the data record (hereafter “Data”), e.g., Tuple=Fieldname+Data. A tuple may be synonymous with and is also referred to occasionally hereafter as a “data-Fieldname pair”. As used herein, the term “pointer” means information that identifies the tuple or Fieldname-data pair, and which occasionally may be referred to as an “identifier” or “identifying information”. This identifying information includes but is not limited to: the record identifier for the data record, the database identifier which identifies the database from which the data record (and hence the fieldname-data pair or tuple) has been ingested, and additional elements or fields associated with the data record (e.g., a timestamp, owner, geographic location, etc.)).

As employed hereafter, the phrase “Digital Stem Cell”, also known or referred to hereafter as a “DSC” or occasionally referred to occasionally as any of a “field-value pair”, a “data-pointer pair”, or simply a “pointer pair”, represents a Data part+Pointer, and is representative of the underlying digital data or information (such as one or more data records as defined above) ingested from the presentation layer. Alternatively, the Data part+pointer that forms the DSC or pointer pair may be occasionally referred to as simply “elemental parts”. A DSC (or the elemental parts) or pointer pair is the end result of encapsulation, whereby each fieldname-data pair (tuple) in a data record that has been ingested from a storage location such as a database has been split or separated into a data part and a fieldname part, a pointer has been created, with the pointer then appended to the data part to form the DSC (pointer pair). As will explained in more detail below, the pointer in general is created by combining the previously-noted identifier information (record identifier, database identifier, additional identifying elements) with the fieldname part that was split from the fieldname-data pair. The formed pointer is then appended to the data part to form the DSC. Each DSC is stored within the data layer in a common storage location, pool, or container known as a “data store”.

The phrase “data store” (also occasionally referred to as an “encapsulated data store”, “data warehouse”, or “data pool”) hereafter represents a single container, pool, or storage location having no structural limitations, where a plurality of these freely associated DSCs are stored. As such, the data store is simply a collection of freely associated, individual DSCs. Unlike traditional database structures, there are no structural barriers in the data store.

The meaning of the term “encapsulation” as used hereafter is the process of creating and storing these DSCs in the data store. Thus, encapsulation represents Applicant's enabling process to merge data records (e.g., digital data elements, records, and the like as noted above) that are ingested, received or accessed from disparate databases (e.g., storage locations, systems and the like as noted above) from the presentation layer, into the data store within the data layer by converting the ingested data records into representative DSCs within the data layer.

Additionally as used hereafter, the phrase “enCapsa objects” (or occasionally also referred to as simply “objects”) may be understood as programming functions adapted to encapsulate or (de-encapsulate) digital data within either a middle or business layer, or in the data layer, depending on the configuration. The enCapsa objects are adapted or configured to both create DSCs in the data layer and also “re-form” the originally ingested digital data (such as data records) from the DSCs in the presentation layer.

Moreover, in the context of this detailed description, the phrase “object library” refers to a library that is represented as a series of programming constructs in the form of exposed functions (the enCapsa objects) that allow encapsulation to form the DSC (or de-encapsulation of the DSC to reconstruct the original data record). In this respect, enCapsa objects are configured so as to pass data between the presentation and data layers. For example, the objects might take a data record from an input or ingested form (as a DSC) and pass it to the data store and, conversely, take the DSC from the data store to something in the presentation layer, e.g., like a dashboard to re-construct the data record from the DSC based on a search query, for example.

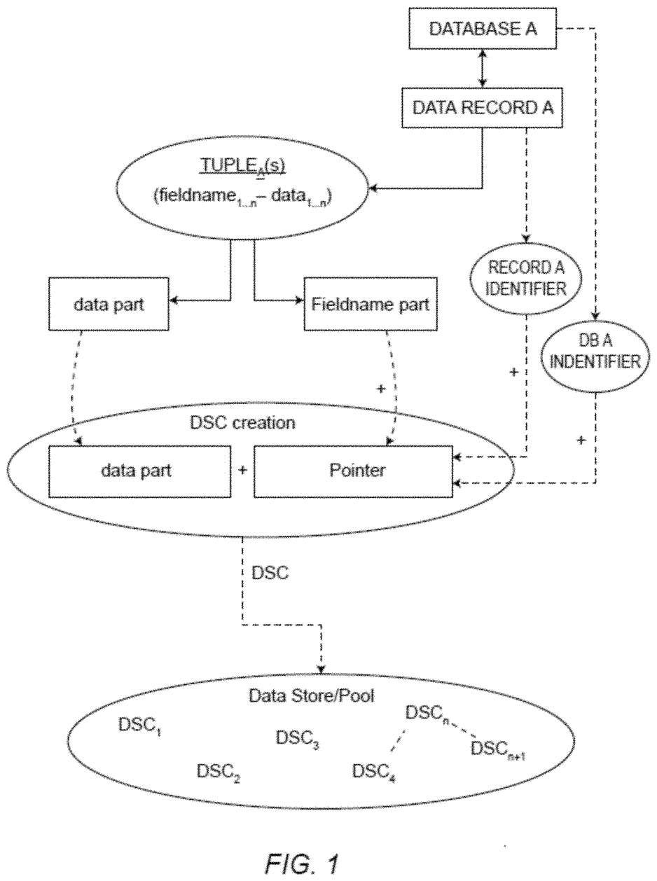

The essence of Applicant's method of creating a ledger for a blockchain has its basis in Applicant's method of encapsulation, which was developed and described in co-pending and commonly assigned U.S. patent application Ser. No. 16/943,645, filed Jul. 30, 2020, and which has issued as U.S. Pat. No. 11,507,556 ('556 patent). As a foundation, FIGS. 1 to 5 of Applicant's '556 patent are replicated here.

FIG. 1 is a simple diagram to highlight the essence of Applicant's process of encapsulation. Before delving into greater detail in regard to the exemplary computer-implemented method(s) and computing systems(s), Applicant provides an overview for purposes of context, and for a follow-on discussion of certain themes or properties attributable to their encapsulation technology.

The essence of Applicant's encapsulation methodology is that any data record in any database can be broken down into fieldname-data pairs (or tuples) to create Digital Stem Cells (DSCs). The general idea is that one can take digital data (such as a data record) from any storage location within the presentation layer, such that within the data layer the data record is separated into a plurality of fieldname-data ingested from the underlying data record. As such, since only these two fields are parsed or pulled out form the underlying data record, structure of the data record becomes a non-issue. In other words, the structure of the underlying data source and the data itself is not taken into consideration.

Recall that each ingested data record is deconstructed into elemental parts having the same structure. The elemental parts are adapted to be freely indexed and stored in a single data store. The stored elemental parts are freely searchable (such as by query by a user via a GUI) in the single data store irrespective of the original format (structured or unstructured) of the data record or the data source from which the data record is ingested. Results of the search are displayed as the originally ingested data records corresponding to their elemental parts as stored within the single data store. The results may be analyzed as desired.

Accordingly, and in real time, each fieldname-data pair is separated into a data part and a fieldname part, and almost simultaneously a pointer is created and the DSC (also called a field-value pair) is formed from the pointer and fieldname-data pair, hence the above-described elemental parts that are freely searchable in the data store. Namely, the pointer is created by combining the fieldname part split out from the pair, the identifier information associated with the data record (record identifier for the data record), and the database identifier which identifies the database that is indexed to in order to ingest the data record stored therein. The now-formed pointer (fieldname+record identifier+database identifier) is appended to the data part that was split from the fieldname-data pair to form the DSC. As noted above, the pointer contains all the identifier and positional information that ties the data field of the data record to its source storage location (its database).

This is shown by FIG. 1, in which an input, retrieved or ingested “data record A” from “database A” in the presentation layer is comprised of a numbers of fields, but only the fieldname field and the data field of data record A is parsed out for encapsulation. Namely, the ingested digital data is encapsulated in the middle or data layers by first breaking down this data from data record A into tuples (i.e., fieldname-data pairs (fieldname_{1 . . . n}-data_{1 . . .n}), splitting each pair into a fieldname part and a data part, and then creating a pointer using the split fieldname part and identifying information for the data part (identifiers shown by dotted line arrows). The pointer thus formed is then appended to the data part to realize a “pointer pair” which is represented as the newly created DSC (field-value pair). The ingesting, breaking down into tuples which are then split out to form the pointer that is combined with the data part represents encapsulation, the birth of the DSC. The DSC thus formed by encapsulation is stored in a common, singular data store with other freely associating DSCs within the data layer. This freely associative nature in a single common data store is analogous to a fish in a school of fish swimming freely within the ocean. Hence, there are no structural barriers.

Creating these DSCs gives certain properties to the tuple, namely: independence, plasticity, uniformity, hierarchy, security, and portability. These properties allow data from disparate systems to co-exist securely within a single store and allow them to be connected. The encapsulation process creates units of data that are self-referencing and able to stand by themselves within a specific pool of data. Each DSC contains all the knowledge it needs to recreate its position in the original database or data store. It also has the ability to exist with other DSCs from other databases or data stores within a common data pool making, by extension, data from different databases or data stores exist in the same space.

DSCs and what is inherent in the concept of the unitary or common single data store can create what is called “linked data”, the enabling concept behind what is known as the Semantic Web. The idea of the Semantic Web is to make it so that data can be linked to other data in a meaningful way so that it can be followed by machines and not necessarily humans. That is, machines should be able to establish a logical path between two or more items of information. For example, John “is the parent of” Janet. As will be shown and described in more detail hereafter, Applicant's encapsulation method has a direct relationship to the concept of linked data.

The common idea behind the Semantic Web and linked data is that, if a user conducts a search for “John Smith”, the user should be able to find John Smith's children or his last three addresses. With encapsulation, if the user searches the data pool for all the data elements belonging to “John Smith”, they should be able to further narrow this down to anything related to “John Smith”simply by increasing the number of required common elements that must be satisfied as return results. So, if the user posits that all results must meet the terms “John”, “Smith”, “Street Address”, “City”, “State” and “ZIP Code” all those DSCs that meet this criteria will be returned. Presumably, anybody who lives or lived at that address, (i.e., John Smith's wife and children) will show up.

These searches are evaluated at the level of the DSC. The data part of the pointer pair that is the DSC is being searched in order to return all data pairs that meet the criteria mentioned. This is done for a reason. Namely, searching the DSCs removes the need to consider structure in searches or queries in the presentation layer. That is, the field name does not have to be mentioned in a search; rather, just a list of terms that are being searched for, such as a name, a city, an occupation, a SSN, and the like. The pointer of the DSC tells the user what field, record, database, data store or document the DSC belongs to.

Again, it is important to note that, at the start of the search, structure of the underlying data source and the data itself is not taken into consideration. The benefit of employing Applicant's method of encapsulation is that any document, database or data store on the planet can be searched. This is powerful because it also means that any search will pull up not just the document or database record that is being looked for, but also (if one increases the number of terms) all the things that the document or database record is about, close to, or refers to—that is, the things it relates to.

Adding to this is the notion that in the common data store the notion of proximity searches among DSCs is really a search for data in quite different databases or data repositories. One can thus envisage a Web or HTML based system that allows you to enter at the “http://” request line a search term, click on any displayed record and be taken to all the records that are related to it.

The process of encapsulation also adds certain, very-specific properties to the ingested digital data, including hierarchy and uniformity, removes the need to create and manage schemas, allows the ingested digital data to reside anywhere, and allows the DSC to store anything. In other words, the DSC can contain anything; that is, the data part of the DSC can be anything. For the uniformity property, a DSC only has to be defined once. Once defined, copies of it can be used again and again to house different data values. By only having to define a DSC once, different entities can share the same field names such as “address” or “phone number” without having to define them again.

For the hierarchy property, a concept that was generally introduced in Applicant's early U.S. patents, each DSC can be part of collections that in turn may be part of other collections. Data in the single data store or pool thus becomes hierarchical, as each DSC carries information through the data record, and database identifiers carry information on the entity areas or collections it belongs to. This is analogous to a document referencing the folder that contains it.

These and other properties of a DSC makes any database infinitely extensible and relatively secure. These properties also permit information from different data storage locations, databases and/or systems, no matter how differently they are structured, to exist in a single space, the common data pool. The possibility for all data to reside in one space means that all data is searchable, regardless of its underlying structure. Searches can take place efficiently and at greater speed simply because all the ingested digital data reside in the same space.

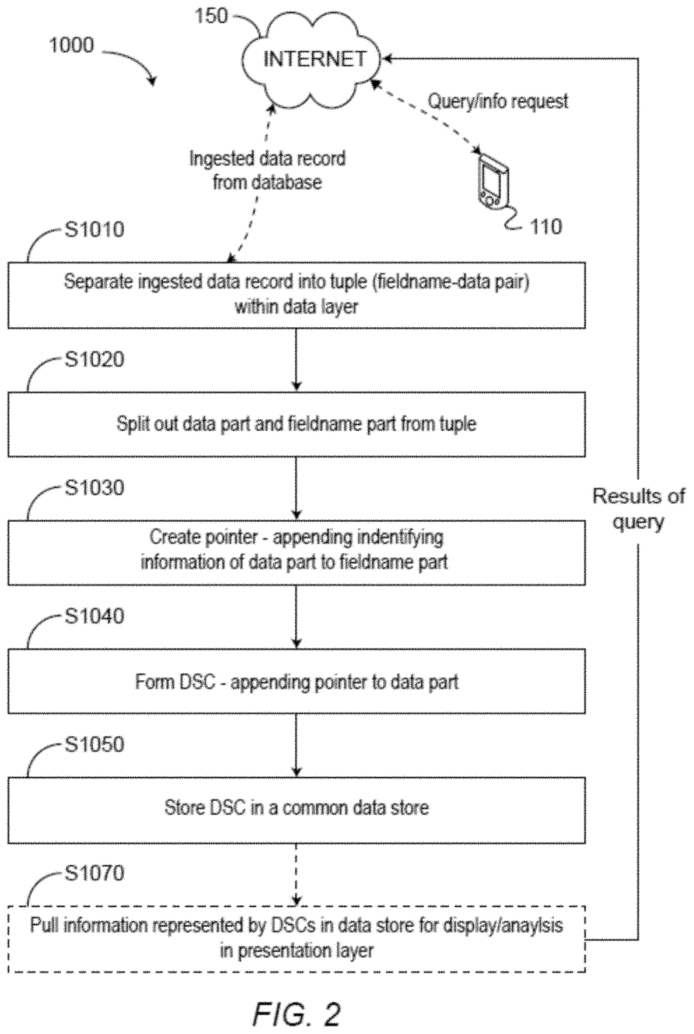

FIG. 2 is a flow diagram to describe a method of encapsulating digital data records in multiple, differently structured and unstructured formats, the digital data having been ingested in the presentation layer from multiple storage locations across the internet 150, according to the example embodiments. For exemplary purposes only, the method is shown in the context of a web user 110 entering a query on the internet 150, such as via a browser.

In method 1000, each ingested data record within the middle layer (or data layer as an alternative) is broken down or separated (step S1010) into one or more tuples (or fieldname-data pairs). For the purposes of FIG. 2 the method of encapsulation 1000 is shown for a single tuple of a data record, it being understood that thousands to millions (or more) encapsulations of tuples may be done per second or minute, depending on the rate of input of data, the processing power of the servers, and the storage space. For the step of ingesting, the files containing the data records are ingested, the files residing in the multiple data storage locations. Hence a given ingested file contains one or more ingested data records. The ingested data record may be understood as any combination of digital data in an unstructured format, and/or in a structured format in the presentation layer, such as multiple data records from various storage locations, where at least two of which have dissimilar field structures with respect to one another.

Next, the tuple is split out (step S1020) into its data part and its fieldname part. As previously noted, identifying information associated with the data part is combined with the split out fieldname part to create the pointer (step S1030). The identifying information includes at least the record identifier for the data record, and the database identifier which identifies the database from which the data record (and hence the fieldname-data pair or tuple) has been ingested.

The identifying information may also include additional elements or fields associated with the data record (e.g., a timestamp, owner, geographic location, etc.). The pointer includes information about its data part, and upon being appended to the data part (step S1040) forms the digital stem cell (DSC, known also as a data-pointer pair or field-value pair). As will be shown, each DSC includes information adapted to be reformed in a presentation layer so as to display the original, underlying data record that corresponds to the DSC for further analysis.

The separating, splitting, creating, and appending steps noted above represent an encapsulation of the ingested digital data record to create or form the DSC. As shown in more detail hereafter, the separating, splitting, creating, and appending functions are executed by object-based programming functions (“enCapsa objects” or simply “objects”) adapted to both encapsulate and de-encapsulate the ingested data records.

Each DSC is then stored (S1050) in a common, single data store in the data layer. Each DSC further adapted to freely associate with other DSCs therein. For example, each stored DSC is freely searchable irrespective of the original structured or unstructured format of its underlying data record, and irrespective of the data storage location from which the data record was ingested, the stored DSCs co-existing without any structural barriers between them in the data store.

The stored DSCs may further be configured as encapsulated data of an extractable or exportable file, such as a .csv file, although any other file format configurable for export or extraction is envisioned herein. Additionally, the DSCs stored in the common data pool may be considered as a merged set, where a search or query is limited to selected tables in the pool. According, it is not necessary to employ any kind of data mapping process, algorithm, or subroutine, as is currently needed in combining digital data from multiple storage sources or databases which have incompatible field structures, as is often the case. The merged data set thus is embodied or represented by the stored DSCs, and can be merged or configured into an extractable or exportable file as noted above.

Optionally, and based on receiving an information storage request from a communication entity in the presentation layer (such as a query by the user 110) one or more of the DSCs are pulled from the data store (step S1060, dotted line box) for display and analysis in the presentation layer so as to access the original, underlying ingested digital data records associated with the DSCs. This function essentially reforms (or de-encapsulates) the originally ingested digital data records. The DSCs retrieved from the common data store in the data layer are thus de-encapsulated using objects for display and review of the original, underlying ingested digital data associated therewith.

The merged data set of DSCs may be adapted to be filtered based on at least one of a common word, phrase, and term. In one example, digital data may be searched in fields common to all unstructured and structured data formats, with the digital data aligned in successive rows by all common fields. The results from the searching and aligning functions may be saved as a new external file of encapsulated information.

Thus, unlike conventional merging of records or tables from disparate databases, which have incompatible field structures requiring a data mapping application to establish a standard associative field structure for both the known and the dissimilar field structures in the records/tables to be combined, the DSCs require no data mapping or translator application to perform a search, query or record retrieval in the presentation layer. This is because the encapsulation process does not require any field structures to initiate, constitute or propagate a search of DSCs stored in the common data store. In fact, no data mapping or translator application is required at any step in the encapsulation process, nor is any data mapping needed upon retrieval or downloading of the original, ingested underlying digital data associated with the DSCs to display in the presentation layer.

Accordingly, the described method for encapsulating and storing information from multiple disparate data sources illustrates how data records can be deconstructed into elemental parts, which can occur at the word level (as in input forms, data tables and metadata) or at the file level (PDFs, images, etc.) In each instance the word, document or image is encapsulated as a DSC and stored in an underlying data store (such as a LUCENE® big data store). Of note, the system/method herein is not a database itself; rather, encapsulation relies on the underlying data store, in this one example LUCENE, to perform persistence. Persistence is “the continuance of an effect after its cause is removed”. In the context of storing data in a computer system, this means that the data survives after the process with which it was created has ended. In other words, for a data store to be considered persistent, it must write to non-volatile storage.

In this light, Applicant's method and system may be viewed a three-tiered model to broker a relationship between the data layer and the presentation layer. Namely, it serves as the middle layer to transform data requests and commands from the presentation layer into persistence in the data layer, by providing intelligence to transform an input form in the presentation layer into a specialized document in a data layer (such as a LUCENE data layer).

In one variant or implementation of the method, Applicant envisions whereby the above method of encapsulating information is performed in a smart computing device. The smart computing device may include but is not limited to one or more of a personal digital assistant, laptop, cell phone, tablet personal computer, RFID device, laser-based communication device, LED-based communication device, mobile navigation system, mobile entertainment system, mobile information system, mobile writing system and text messaging system. The common data store described above is configurable to be part of the device, or connected to the device, stored on but not connectively integrated with the device, or generated or hosted by the device. Also, the data store is adapted to be at least one of transmitted, transferred, transformed or translated by the device.

In another variant or implementation of the method, Applicant envisions a non-transitory, computer-readable information storage media having stored thereon information. When the stored information is executed by a processor the above encapsulation method is iterated. In another potential commercial application, Applicant envisions a control method embodied as a middleware product, which is configured to perform the steps of FIG. 2. Namely, this could be commercially sold as a “plug-and-play” middleware product or middleware which lays on top of an existing infrastructure, system, network, and the like. The middleware encapsulates digital data in multiple, differently structured and unstructured formats that is ingested from multiple data storage locations.

In another commercial implementation of the method, Applicant envisions the development of a search engine (private or public-facing) for presenting information in a presentation layer based on a query by a user. The search engine may include one or more computers and one or more storage devices storing instructions that are operable, when executed by the one or more computers, to cause the one or more computers to perform the steps in method 1000 so as to present the information collected in response to the query to the user.

A further specially-envisaged commercial application is in the form of a peer-to-peer (P2P) file sharing service which is adapted to iterate method 1000. In this implementation, the P2P service has its own P2P network with one or more nodes, and implementation of the method shown in FIG. 2 would invoke a data browser enabling a user or machine to access media file content (such as hooks, music, video files inclusive of movies and episodic series content, video or electronic games, etc.) by searching other connected computers on the P2P network to locate the desired content. In an example, one or more nodes of the P2P network are end-user computers and distribution servers.

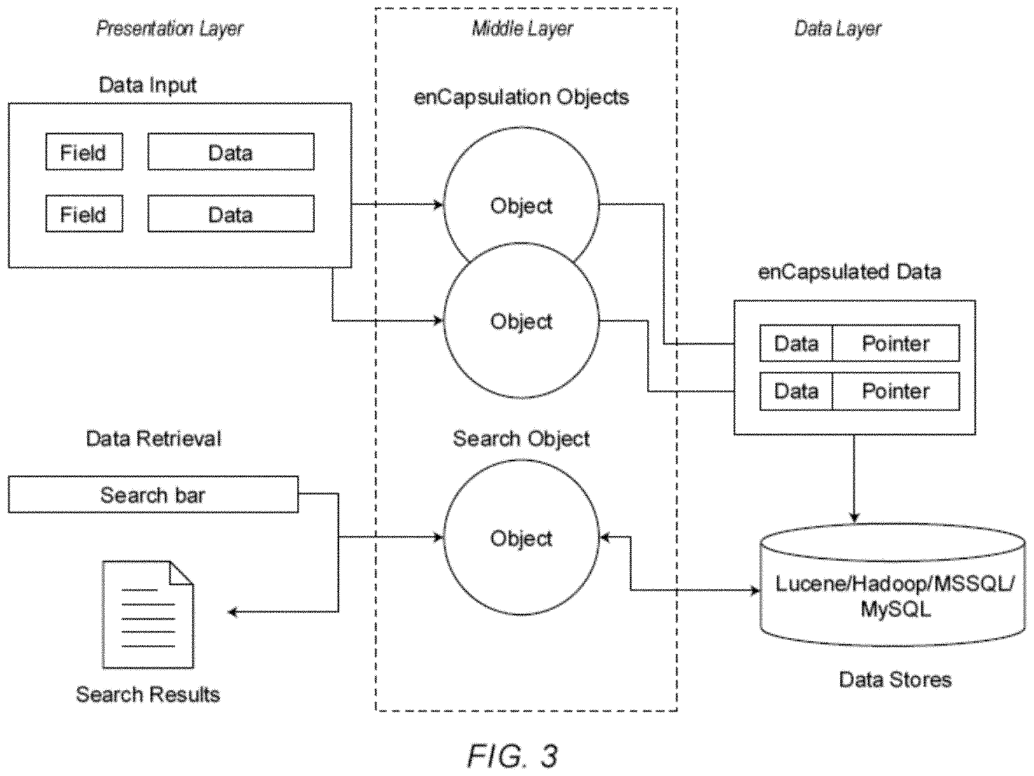

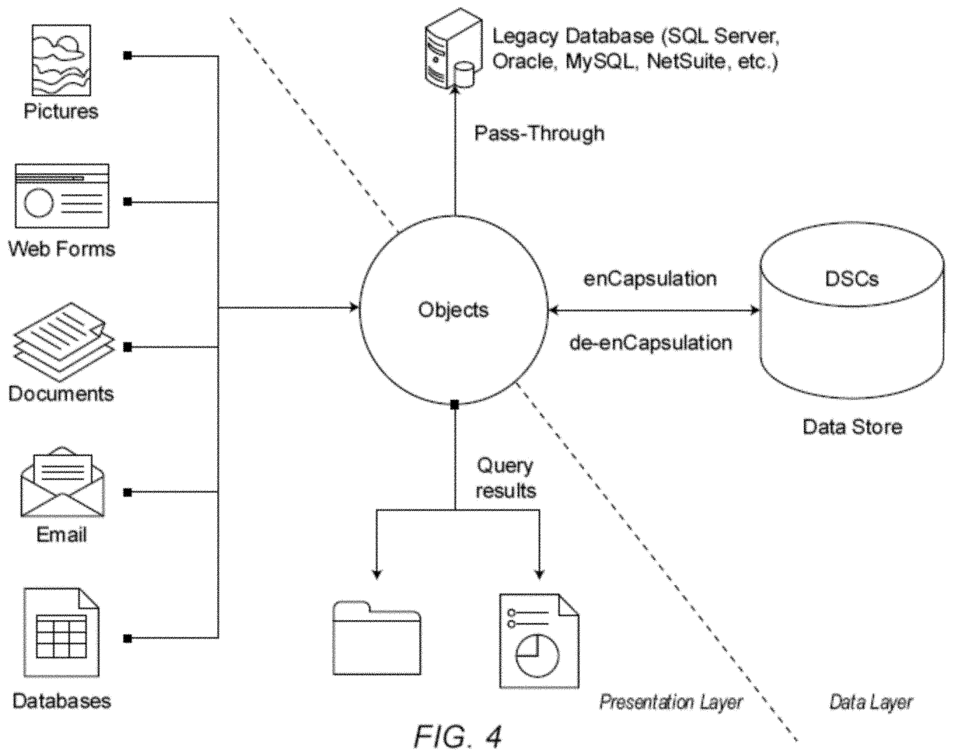

FIGS. 3 and 4 are block diagrams to further describe the functionality of the objects in accordance with the example embodiments. Referring to FIGS. 3 and 4, enCapsa Objects (or simply “objects”) are part of a simple but powerful programming library that can be installed within any development environment to tie massive amounts of disparate data together. Developers and integrators can use the power of Applicant's encapsulation process in their own projects to bring together digital data from multiple sources to be searched as though it were a single database.

Developers install object libraries, reference them in their code and use the menu functions of the API possesses to pass data from input forms, ingest tools, and links to legacy databases to the data store. Any developer can install a simple search bar on a windows form or on any webpage to search the data store for information from anywhere in the enterprise, or employ any off-the-shelf tool to analyze the global data returned in response to a search query.

The objects have full database emulation, with an ability to store, manage and manipulate massive amounts of data in their own right (possibly on the order of zettabytes (depending on the processing capability of the underlying server/nodes or processors), where 1,024 megabytes=1 gigabyte; 1,024 gigabytes=1 terabyte; 1,024 terabytes=1 petabyte; 1,024 petabytes=1 exabyte; one sextillion bytes (10²¹ bytes or 1,024 exabytes)=1 zettabyte). The objects permit databases and digital data elements with varying structure to exist in the same space. They can be dynamically created, updated and/or removed (i.e., on the fly).

The objects lie within the middle layer (also known as the business layer in a typical application architecture) between the presentation and data layers, although objects may be full participants in the data layer. As shown in FIGS. 3 and 4, objects are configurable to take data from the presentation layer (such as a search query or information request) and then apply it to the data layer. In a sense, objects act like bots or agents (“soldiers” following an order) to break-up and store digital data in the data layer that is ingested from the presentation layer. Data from many different presentation layer sources can be stored in one space, making searching and analyzing of this disparate data very easy.

Thus, the aforementioned objects present a unique way to manage and unite data within the enterprise and between various enterprises. By simply placing elements of the API within code, developers and designers can unite vast amounts of disparate data, turning over big data projects from that typically take months into mere minutes.

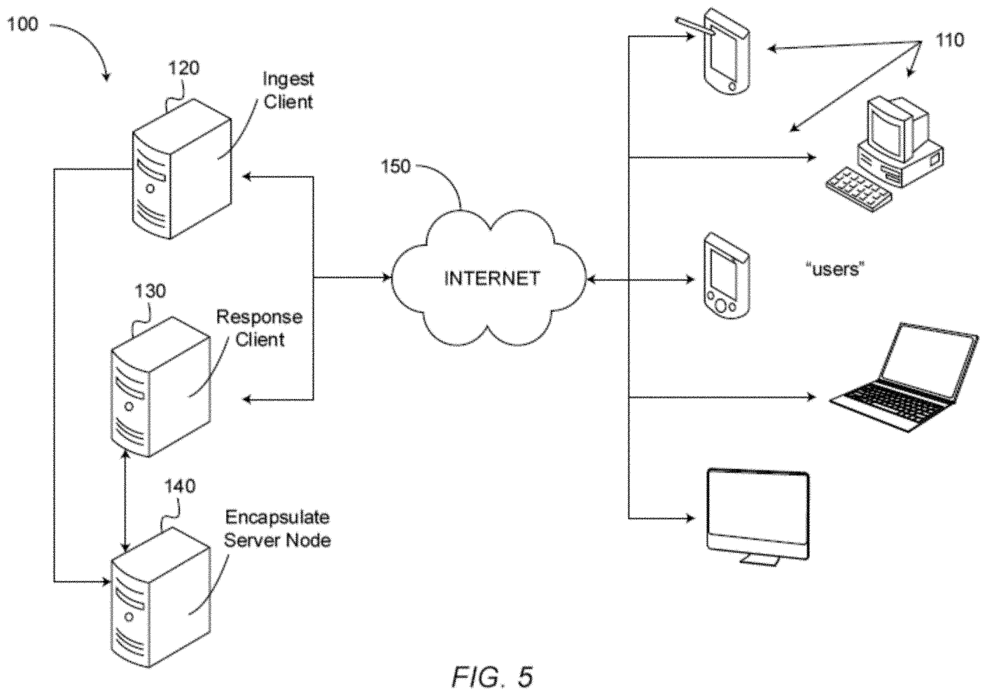

FIG. 5 illustrates an exemplary general computer system block diagram adapted to implement the method. Computer system 100 is adapted to encapsulate digital data records in multiple, differently structured and unstructured formats that is ingested in the presentation layer from multiple data storage locations. System 100 in general comprises a processing hardware set and a computer readable storage device medium. The processing hardware set is structured, connected and/or programmed to run program instructions stored on the computer readable storage medium so as to iterate the method 1000 of FIG. 2.

Referring now to FIG. 5, computer system 100 includes one or more application servers or clients, shown here as an ingest client 120, a response client 130, and an encapsulate client 140 (also referred to hereafter as a “server node”), which are adapted to interface with one or more computing device(s) employed by users 110 connected over a network in the presentation layer, here shown as the internet 150. Internet 150 may be any network topology, including one or more of a personal area network (PAN), a local area network (LAN), a campus area network (CAN), a metropolitan area network (MAN), a wide area network (WAN), a broadband network (BBN), and the like.

The ingest client 120 makes the connection between the objects within the exemplary method 1000 and the digital data “out in the world”. Namely, ingest client 120 ingests data records from the presentation layer that may be in multiple, differently structured and unstructured formats from multiple data storage locations, databases, system and the like.

Within the middle layer, the server node 140 performs the functions to encapsulate the ingested data record as DSCs, Namely, the object-based programming functions within server node 140 execute the separating, splitting, creating, and appending functions of FIG. 2 to both encapsulate and de-encapsulate the ingested data records. The formed DSCs are stored within the data layer in the data store of server node 140. The data store may be internal to the server node(s) 140 or external, or distributed among multiple nodes.

Of note, instead of server store 140, system 100 may include an application programing interface (API) to which calls are create for both saving and retrieving data, inclusive of functions which perform the separating, splitting, creating, and appending functions to both encapsulate and de-encapsulate the ingested data records, such as data records of off-chain data stored in various disparate data stores external from a blockchain.

The information represented by these DSCs may then be pulled from the data store of server node 140 within the data later by the response client 130 for display and analysis in the presentation layer. This function essentially reforms (or de-encapsulates using objects) the originally ingested digital data records. In an example, such may be implemented in the form of an information storage request being received from a communication entity (such as user 110) to retrieve one or more of the DSCs from the common data store, for display and review of the original, underlying ingested data record associated with the DSC. Said another way, upon a query by a user 110 to the system 100, the response client 130 accesses the data store in the server node 140 to retrieve results information based thereon. The results are relayed directly back to the user 110 as an immediate reply to the query.

In an example implementation of the method 1000, the newly created DSCs may be stored in a large database such as LUCENE®. Developed by the Apache Software Foundation, LUCENE is a high-performance, full-featured text search engine library written entirely in JAVA. It is a technology suitable for nearly any application that requires full-text search, especially cross-platform.

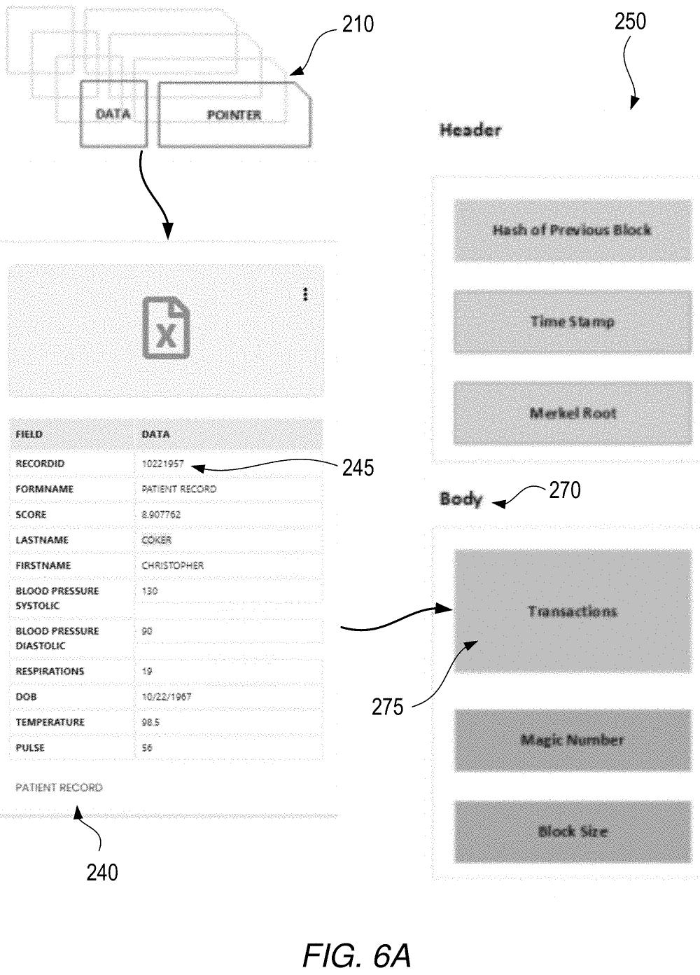

Blockchain and the Distributed Ledger. FIG. 6A is a simplified block diagram to illustrate in general a method for creating a ledger dynamically in a blockchain network according to the example embodiments. FIG. 6A in particular shows how a method of encapsulation to create field-value pairs (or DSCs) can be added to the functionality of a blockchain. In FIG. 6A there is shown a plurality of digital stem cells (DSC″, referred to in this example as field-value pairs 210) representing an original patient electronic data record (“patient EDR 240”) from an off-chain or off-block external patient electronic data record (EDR) system. This patient EDR 240 is to be placed on-chain as transactions 275 added to a body section 270 of a block 250 of the blockchain, as shown in FIG. 6A. The patient EDR 240 has 11 fields of data, including name, and birthdate, various vital signs data, and a record identification number, see RECORDID 245.

Particularly, the field-value pairs 210 representing this patient EDR 240 (which were created in accordance with Applicant's method of encapsulation, as previously described above in FIGS. 1 to 5 and associated description) can create record schemas dynamically (“on-the-fly” or “in real time”). This is so as to be able to add various pairs 210 representing the various fields and data in the original patient EDR 240 to the block 250 as transactions 275. These field-value pairs 210 thus represent blockchain transactions. Moreover, any new data which is added to the patient EDR 240 (such as updated vital signs or new fields added in the EDR 240) are also added dynamically as transactions 275 to the body portion 270 of the block 250.

The patient EDR 240 (as represented by these field-value pairs 210) can thus be viewed as a ledger; specifically it is the actual plurality of field-value pairs 210 created through encapsulation represent a distributed ledger by which data can be added as transactions 275 across all blocks 250 of the blockchain. The method of encapsulation that births these field-value pairs 210 provides the ability to create infinite records of infinite length on the fly to be added as transactions 275 to any given body portion 270 of a given block 250 in a blockchain system (such as a computer-implemented blockchain system shown hereafter) without having to define any of the data record structure beforehand. All that is needed is to simply add the IDs (RECORDID 245) associated with the encapsulated data records. Accordingly, in looking at the structure of the blockchain inclusive of the nature of the conventional distributed ledger of today, today's distributed ledger is replaceable by the collection of DSCs (e.g., field-value pairs 210) created via Applicant's method of encapsulation as first described in its '556 patent.

Recall that a blockchain is immutable in nature: once a blockchain is created, it cannot be edited or deleted. If a transaction needs to be modified or deleted, new transactions must be proposed, which require approval via the Proof of Work consensus algorithm. Only if a majority of nodes approve, these new transactions will be accepted. However, what is proposed here does not touch, edit, or modify the block chain or modify a transaction. What encapsulation does is look and act on information and data in a completely different way, adding flexibility to the transactions in the blockchain so as to make it easier to create blocks.

FIG. 6A thus illustrates the dynamic, real time, or on the fly aspect of bringing new data into the block on-chain. The data-pointer or field value pairs from ad hoc readings taken from the various fields of the original patient EDR 240 come together to re-form the patient EDR 240. This record is stored on-chain as a series of transactions in the block. In other words, with no limitations on record structure, the patient data, represented as a series of field-value pairs, can be added as transactions into the body portion of the blocks of the blockchain. The patient EDR 240 can grow and be added as new transactions into the block with each new vital sign being updated or added by a healthcare facility into the patient EDR 240 database.

FIG. 6B shows the exact same relationship as FIG. 6A, but for a patient EMR 240′ of a completely different patient having completely different fields, structure, and data values. In FIG. 6B, there is shown a patient with a different name, many different vital signs data, and a different record identification (245′). Using the process of encapsulation, and because the structure underlying the patient EMR 240′ is irrelevant, the field-value pairs 210 or digital stem cells created by encapsulation of this differently structured patient EMR 240′ can also be added dynamically (in real time) as transactions 275 into the body portion 270 of the block 250.

FIG. 6B thus illustrates how a new ledger can be created on the fly for a different patient. This is possible because as previously noted, encapsulation looks at data in a completely different way, is not tied to underlying structure of the data record itself, and adds flexibility to blockchain transactions. Since the uniform DSCs (field-value pairs 210) are stored natively in a single store, ledgers or data records can be created on the fly without having to first define the structure of the distributed ledger or the data record. This is possible because the field-value pairs (DSCs) are defined at runtime. The DSCs do not need to be defined beforehand, as is required with traditional database architectures using traditional methods of cleaning, massaging and then storing disparate data.

Accordingly, and with reference to FIGS. 1, 6A and 6B, there is a method of creating a distributed ledger for a blockchain via encapsulation of off-chain data envisioned herein. The off-chain data is represented as one or more data records having differently structured and unstructured formats. The data records are ingested from multiple different and disparate data storage locations external to the blockchain.

The method thus includes creating, via encapsulation (as shown in several of the steps of FIG. 1 to realize the DSCs) a plurality of field-value pairs (i.e., DSCs). These field-value pairs of course are representative of the given external data record of off-chain data. The plurality of field-value pairs are created dynamically without regard to the underlying data structure of the given external data record of off-chain data. As described in FIGS. 6A and 6B, the created plurality of field-value pairs are then as blockchain transactions to a body portion of each of one or more blocks across the blockchain.

In an aspect of the method, and as noted above, any new data added externally into the given external data record of off-chain data at its given storage location external to the blockchain is also added dynamically as blockchain transactions to the body portion of each block across the blockchain. Accordingly, and also as previously noted, the plurality of field-value pairs created through encapsulation represent a distributed ledger by which data can be added as blockchain transactions across all blocks of the blockchain.

In another aspect of the method, infinite external data records of off-chain data, at an infinite length, are adapted to be added on the fly (with their associated record identifications) as blockchain transactions without having to define any of the data record structure beforehand.

In another aspect of the method, the ingestion of the given external data record of off-chain data further includes ingesting files containing additional external data records, the files residing in multiple data storage locations other than the given storage location external to the blockchain in which the given external data record of off-chain data is stored.

In yet another aspect of the method, encapsulation further includes: (a) separating the ingested given external data record of off-chain data into a plurality of tuples, (b) splitting out a data part and a fieldname part from each tuple, (c) creating a pointer by combining the fieldname part, a record identifier of the given external data record of off-chain data, and a database identifier of its given storage location, (d) appending the created pointer to the data part to form a field-value pair, each formed field-value pair having the same structure and each formed field-value pair representing encapsulated data of the given external data record, and (e) storing each field-value pair in a single data store.

In one aspect, these steps of separating, splitting, creating, and appending may be executed by object-based programming functions adapted to both encapsulate and de-encapsulate the ingested given external data record of off-chain data. The object-based programming functions both create the field-value pairs and reform the originally ingested given external data record of off-chain data from the field-value pairs. In another aspect, and as previously noted with regard to FIG. 1, an API may be provided for the creation of the plurality of field-value pairs. This API includes calls for both saving and retrieving the ingested given external data record of off-chain data. These calls include steps that perform the aforementioned separating, splitting, creating, and appending functionality to encapsulate and de-encapsulate the ingested given external data record of off-chain data.

In yet a further aspect of the method, and as previously noted earlier, each stored field-value pair (DSC) may be freely searchable irrespective of the original structured or unstructured format of its underlying data record, and irrespective of the data storage location from which the data record was ingested, the stored field-value pairs co-existing without any structural barriers between them in the single data store.

In light of how the above method employing encapsulation to generate field-value pairs that effectively create (or replace) a distributed ledger in a blockchain system, some of the essential features and properties of encapsulation underpinning the significance of this are further described, particularly as pertaining to burgeoning technologies blockchain technologies.

One notion with encapsulation is that any data element or data record can be broken down into extended field-value pairs represented as DSCs. The idea is that one can take any database record, isolate the field-data pairs, remove the field part, and replace the field part of the data record with a pointer containing not just the field name but all the positional information that ties the data element to its database. The replaced pointer with the data thus constitutes the field-value pair or DSC.

Possessing positional information means that a DSC can be reconstituted into a prior tuple, or matched to other DSCs to form the original data record. However, this positional information also means that these tuples can be added to any data record, given the right record identifier. A data record can thus be freely expanded without changing the original data elements of that record. This is the fundamental construct behind the blockchain distributed ledger, and why an encapsulated data logically minors a distributed ledger.

The process of encapsulation can thus create the distributed ledger, which is the heart of the blockchain transmission technology. Each tuple in an encapsulated record (represented by the DSCs) corresponds to a transaction in a standard blockchain ledger, Additionally, properties of the DSC and the tuples it recreates expand on the basic properties of the distributed ledger to provide not only mobility and plasticity, but also security and portability to the distributed ledger of the blockchain. These properties are detailed below and, coupled with the fact that an encapsulated record is both immutable and flexible, enables it to exist as a ledger within a larger blockchain construct.

independence. Independence means that DSCs can exist free of other DSCs, because all information regarding a DSC's relationship to other structures is stored within the DSC itself. This independence property also means that an individual DSC can be stored anywhere on the planet and, as long as there is a connection, can be brought together to reestablish the whole or entire data record. Regarding both distributed systems and AI systems, abstractive technologies that provide data streams able to exist in and on multiple systems is a necessity.

By its nature, the blockchain requires independence in its storage elements. A distributed ledger existing on widely located nodes requires that die elements of die ledger show independence in. behavior. This is so the nodes can properly exist as independent nodes in a larger connected system. Again, the DSC as a self-defining entity supports independence of the distributed ledger system. Moreover, the DSC also allows ledgers to exist on remote systems distributed among multiple servers.

Plasticity. Plasticity means that inherent in the DSC's structure is the fact that the “value” in the {Data:Value″} construct can be any digitized entity, from text strings to video files. Plasticity also means that each DSC, despite its value type, can exist with DSCs front the same or other databases without changing the character of the final data store.

The use of DSCs enable a distributed ledger to utilize non-traditional parts. For example, the plasticity property of DSCs enable extra dimensions to be added to the data stream. In the blockchain the distributed ledger can add other elements, including sound and other media, to the transaction record.

Uniformity. This means each DSC is reusable, since the DSC can be defined by the same four (4) type of structures, regardless of the database or data store it resides in, specifically: {FieldID: “FirstName”; DataID: “Chris”, RecordID: “32”, DatabaseID: “Contacts”}. The structural uniformity of the DSC makes irrelevant the database definition disparity that typically occurs naturally within an organization, when people define fields containing the same information differently. A DSC only has to be defined once. Once defined, copies of that DSC are used again to house different values. This means that within an organization, for example, different areas of that organization can use the same field values without having to define them again.

Basically, in such a case each DSC would only differ in what we put in the “Value” tuple of the DSC. For example, this DSC (same as above): {FieldID: “FirstName”; DataID: “Chris”, RecordID: “32”, DatabaseID: “Contacts”}, can be reused to house the Name “Joe” without having to define or redefine any of the other tuples. So the previous construct now becomes: {FieldID: “First Name”; DataID: “Joe”, RecordID: “32”, DatabaseID: “Contacts”} without any change to the surrounding tuples.

The uniformity of the DSC thus allows different departments to use the same filenames, for example. This means that fields like Address can be used throughout an organization, illuminating the problem where different departments name the same data definition with different names i.e. {FIRST_NAME:VALUE} and {FIRST_NAME:VALUE}.

This becomes important to the Web 3.0, as data across platforms only need to be defined. once. This is especially true of the Blockchain, where distributed ledgers have to be created on the fly. The ability to include predated elements enhances this process. Predefined transactions defined at the atomic level can be added to the distributed ledger in real time. Similarly, transactions can be built from existing data elements, minimizing the need for these elements to be built repeatedly.

Hierarchy. Hierarchy means that each DSC can be part of collections which in turn can be part of other collections. Encapsulated data becomes hierarchal as each field-value pair or DSC carries information of the data record and database identifiers onto the entity or collections it belongs to. This is analogous to a document referencing the folder that contains the document. This hierarchical property of the DSC is highly applicable to the blockchain, where data in distributed ledgers can reference other higher ledgers or lower-ranked ledgers contained therein. This brings a certain organizational ability to the distributed ledger of a blockchain, and enabling ledgers to be able to reference one another at the transaction level.

Data Independence. Data independence means that data can exist anonymously in the data stream. A DSC's location can be random because it holds the information as to its whereabouts (i.e., the relationships to the other DSCs) within its own structure. This confers an inherent level of security to a data value, as the locations of all the values in a record set are known only to the program, but not to the observer. This randomness makes data within the DSCs invisible to the casual observer. For example, a data element sequence of “a, b, c . . . ” can be placed non-sequentially as in “a-z-v-s-b-x-d-s-c” and still retain its identity.

Data independence is a clear requirement of the blockchain, as it enforces the distributed node system. The independence property of all DSCs supplies a level of inherent security to the blockchain, not only at the node level, but also at the transaction level. This is true in the management and storage of sampling data as it resides on a platform to be analyzed.

DSC independence also confers portability to data. This means that DSCs can be stored in different data stores without losing their essence and without disrupting the organization of the data stores they are transferred to. A DSC further can be moved individually, or as a collection of DSCs, but in each case the DSC or DSC collection does not lose its character. This is crucial to both AI and distributed system technologies, and goes to the heart of the blockchain.

Existing on various nodes, independent of all other nodes, and at the heart of the distributed ledger system, the concept of the DSC provides these features and ability at an atomic level. Each DSC can “float”separately on the node. This means that any part of the blockchain, ether in the header or body, can exist independent of all other elements, yet still be treated as a whole and moved throughout a network, system or the Web. This is possible either in a singular form or as a plurality or collection.

Accordingly, data from traditional sources can be combined using DSCs. Data records or data elements from any database ingested by the encapsulation methodology is broken up into field-value pairs (DSCs), and combined with data read in from other databases, so as to form a common data pool of unitary and uniform elements (DSCs. These DSCs are thus searchable in combination.

This represents a bottom-up approach to data searches that does not rely on the structure of the database to frame the search. Searches of the single store of uniform DSCs are a free text search of all the DSCs in the store. When one or more matches are returned, the original database's data record object is rebuilt and displayed.

With DSCs able to be derived from multiple databases, it follows that data records from multiple databases are returned. Although each returned data record will have one or more data values in common, these returned data records will be of different lengths with different structures. Nonetheless, this effectively represents a data merge, since data records would have been brought together from different data sources (different databases).

Congruity. The key to the data merge capability above is maximizing congruity; that is, maximizing the number of fields from all the disparate or different databases that match. The better the congruity, the better the data merge capability. This stands to reason, as the basic modus for database merges is mapping a field in one database with its corresponding (but not necessarily same-named) partner in another database. Congruity occurs where there is a natural one to one (1 to 1) congruence between fields in two or more databases.

DSCs maximize congruity through data field matching. Encapsulation assumes that DSCs with similarly named fields point to the same Data Field and places them in the same DSC type in the data store. This allows for congruity to be established automatically as the data from two tables is read. Data congruity is helpful in the blockchain, as reusable elements defined in the body of the blockchain can be searched with a greater efficiency with more congruity as defined at the level of the DSC.

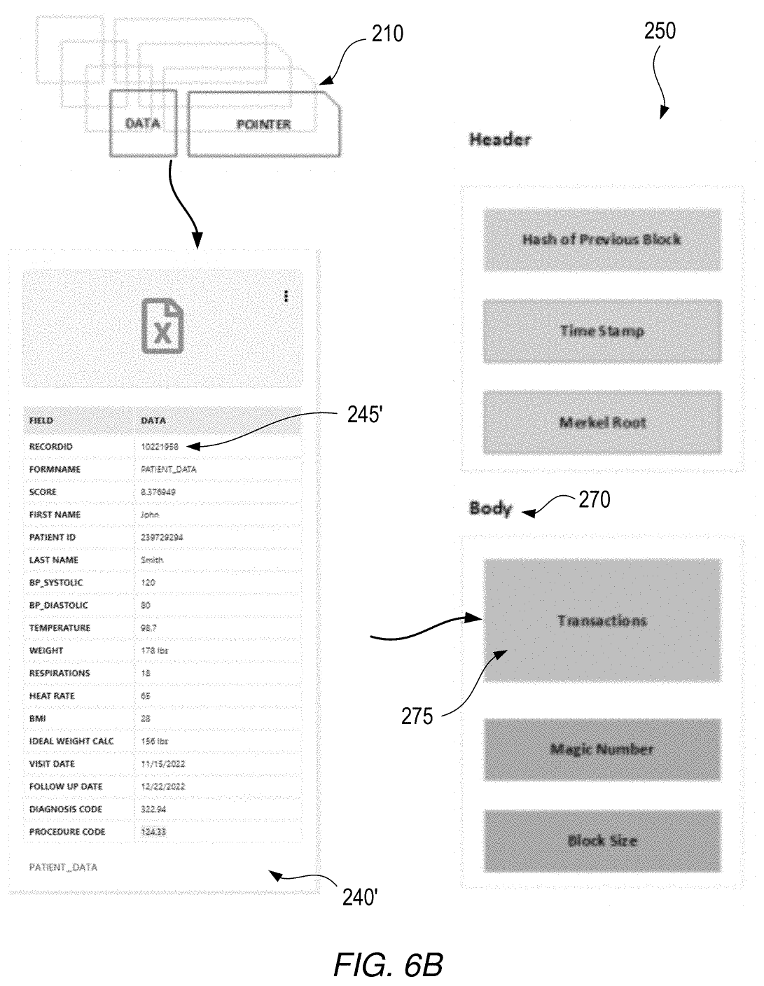

FIG. 7 is a simplified block diagram to illustrate a generic blockchain network environment according to the example embodiments. FIG. 7 is similar to FIG. 5 but described in terms of a dedicated blockchain environment. As illustrated in FIG. 7, a generic, computer-implemented blockchain system 330 is operatively coupled, via a network 301, to a user device 310, to a plurality of nodes 320, to a generic commerce system, here shown exemplary only as a patient electronic data record (EDIT) system 340, and to a data storage archive 350. In this way, blockchain system 330 is able to send information to and receive information from each of these components within the environment 300. This is merely one example of a generic environment 300; it will be appreciated that in other embodiments one or more of the systems, devices, or servers may be combined into a single system, device, or server, or be made up of multiple systems, devices, or servers.

Network 301 may be a system specific distributive network receiving and distributing specific network feeds and identifying specific network associated triggers. The network 301 may also be a global area network (GAN), such as the Internet, a wide area network (WAN), a local area network (LAN), or any other type of network or combination of networks. The network 301 may provide for wireline, wireless, or a combination wireline and wireless communication between devices on the network 101.

In some embodiments, the user 302 (like user 110 of FIG. 5) may be an individual or system that desires to implement the benefits of blockchain architecture and data storage over the network 301, such as by automatically migrating, data through the structure over time. In some embodiments a user 302 is a user or entity completing a transaction to be recorded on a blockchain. In other embodiments, the user 302 is a user or entity managing data storage on the blockchain. In sonic embodiments, the user 302 has a User device 310, such as a mobile phone, tablet, or the like that may interact with and control the recordation and validation of blocks on the blockchain through interaction with the components of environment 300.

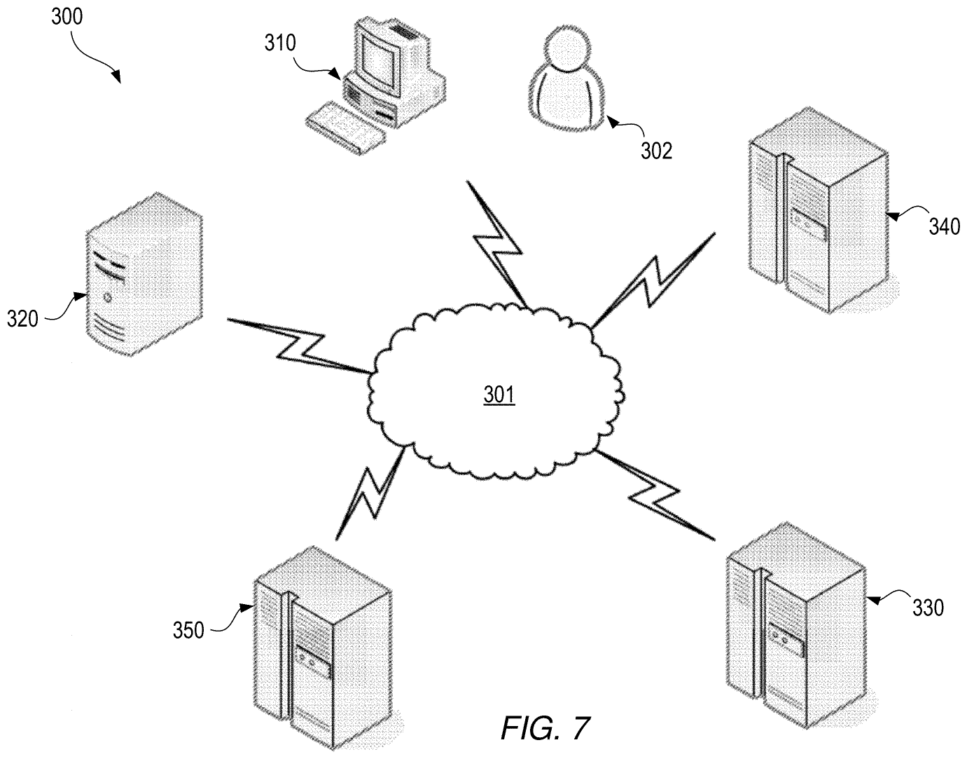

FIG. 8 is a simplified block diagram to illustrate a generic user device according to the example embodiments. User device 310 may be any of the smart electronic devices shown in FIG. 5 in use by the web user 110; here user device 310 is as represented in a blockchain environment. As such, user device 310 may generally include a processing device or processor 402 communicably coupled to devices such as, a memory device 434, user output devices 418 (for example, a user display device 420, or a speaker 422), user input devices 414 (such as a microphone, keypad, touchpad, touch screen, and the like), a communication device or network interface device 424, a power source 444, a clock or other timer 446, a visual capture device such as a camera 410, a positioning system device 442, such as a geo positioning system (GPS) device, an accelerometer, and the like, including one or more chips and the like. The processing device 402 may further include a central processing unit 404, input/output (I/O) port controllers 406, a graphics controller or GPU 408, a serial bus controller 410 and a memory and local bus controller 412.

Processing device 402 may include functionality to operate one or more software programs or applications, which may be stored in the memory device 434. For example, the processing device 402 may be capable of operating applications such as the user application 438. The user application 438 may then allow the user device 310 to transmit and receive data and instructions from the other devices and systems.

The user device 310 comprises computer-readable instructions 436 and data storage 440 stored in the memory device 434, which may be the computer-readable instructions 436 of a user application 438. In some embodiments, the user application 438 allows a user 302 to access and/or interact with content provided from an entity. In some embodiments, the user application 238 further includes a client for altering data requirements of data on the block chain. The user application 438 may also allow the user to manage data stored on the blockchain by altering data requirements of the data and determining storage location and parameters.

The processing device 402 may be configured to use the communication device 424 to communicate with one or more other devices on the network 301 such as, but not limited to the block chain system 330. In this regard, the communication device 424 may include an antenna 420 operatively coupled to a transmitter 428 and a receiver 430 (together a “transceiver”), and modem 432. The processing device 402 may be configured to provide signals to and receive signals from the transmitter 428 and receiver 430, including signaling information in accordance with the air interface standard of the applicable BLE standard, and/or of a cellular system of a wireless telephone network and the like that may be part of the network 301.

In this regard, the user device 310 may be configured to operate with one or more air interface standards, communication protocols, modulation types, and access types. For example, the user device 310 may be configured to operate in accordance with any of a number of first, second, third, fourth, and/or fourth-generation wireless communication protocols, e.g., second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous (DMA (TD-SCDMA), with fourth-generation (4G) and fifth generation (5G) wireless communication protocols, and/or the like.

User device 310 could also operate in accordance with non-cellular communication mechanisms, such as via a wireless local area network (WLAN) or other communication/data networks. The user device 310 may further be configured to operate in accordance BLUETOOTH®, low energy audio frequency, ultrasound frequency, or other communication/data networks.

User device 310 may additionally include a memory buffer, cache memory or temporary memory device operatively coupled to the processing device 412. Typically, one or more applications 438 are loaded into temporarily memory during use such as any computer readable medium configured to store data, code, or other information. Memory device 234 includes volatile Random Access Memory (RAM) with a cache area for the temporary storage of data. Memory device 234 may also include embedded or removable non-volatile memory, which additionally or alternatively can include an electrically erasable programmable read-only memory (EEPROM), flash memory or the like.

Though not shown in detail, environment 300 further includes a genetic commerce system, which for purposes of explanation only is shown as a patient electronic medical record (EMR) system 340. In general, EMR systems may be understood as an electronic record of health-related information on an individual that can be created, gathered, managed, and consulted by authorized clinicians and staff within a health care organization. Examples of well-known EMR systems in the US include ADVANCEDMD™, ATHENA HEALTH™, CARECLOUD™, GREENWAY HEALTH INTERGY™, KAREO™, NEXTGEN HEALTHCARE™, SEVOCITY™, THERANEST™, VIRENCE HEALTH CENTRICITY™, and WEBPT™. EMR systems are designed so as to provide substantial benefits to physicians, clinic practices, and health care organizations. EMR systems facilitate workflow and improve the quality of patient care and patient safety.

EMR system 340 is connected to the user device 310, nodes 320, the blockchain network system 330, and data storage archive 350. EMR system 340 could be and may be associated with one or more healthcare or medical insurance enterprise or entity, in this way, while only one EMR system 340 is illustrated in FIG. 7, it is understood that multiple networked systems could make rip EMR system 340 within environment 300.

EMR system 340 generally comprises a communication device, a processing device, and a memory device, with computer-readable instructions stored thereon, such as multiple applications with the EMR system 340 for processing patient data. EMR system 340 is configured to communicate with other components of the environment 300 as shown in FIG. 7 to complete transactions on the blockchain.

In some embodiments, EMR system 340 may be part of the block chain. Similarly, in some embodiments, the blockchain system 330 may be part of EMR system 340. Alternatively, EMR system 340 may be distinct from the blockchain system 330. Communications back and forth may be conducted via a secure connection generated for secure encrypted communications.

Nodes 320 and data storage archive 350 may be constituted similarly to user device 310 and EMR system 340. In an example, the nodes 320 are designed to maintain the block chain's transaction record, although different nodes 320 may have different functions. However, not all nodes are required to keep this full record, because not all nodes have the same functionality or purpose. In another example, the nodes 320 may be user devices 310 forming a plurality of networked devices participating in a blockchain environment, Data storage archive 350 may typically be used for long term data storage for data on a blockchain (“on-chain storage”), wherein data may be moved to the data storage archive for permanent storage or storage off-chain or with limited blockchain characteristics.

The blockchain iterated by blockchain system 330 in environment 300 is a database ledger (later described) distributed across the multiple nodes 320. These nodes 320 synchronize the ledger data using a particular communication protocol called “Gossip protocol”. A node 320 will broadcast data to neighboring nodes 320, and those nodes 320 continue to broadcast to their neighboring nodes 320, and so on, and so forth until all nodes 320 in the network environment 300 have received the data. This peer-to-peer network of nodes 320 is the core layer of blockchain architecture.

Generally speaking, a blockchain node is like a server that helps to maintain the blockchain's transaction record. However, not all nodes are required to keep this record, because not all nodes have the same functionality or purpose. Although not described in detail, there are three primary types of nodes: full, pruned, and archival, each serving differing functions. The different roles nodes play depends upon the particular requirements of the blockchain network. For example. Corda Blockchain has two node types, one for the client and one for validating transactions.

Archival nodes may further be broken down by functionality into additional mining nodes, staking nodes, authority nodes, master nodes, light nodes and special nodes. Mining nodes are archival full nodes that can add blocks to the chain, validate transactions, and get rewards. Staking nodes work similar to mining nodes but require less computational power, but staking nodes must hold crypto coins and offer a specified amount as collateral to validate blocks. Authority nodes are also responsible for creating and validating new blocks in the blockchain, but also authorize other nodes to join the network or gain access to a particular data channel.

Master nodes cannot add blocks to the chain; their function is to keep a record of transactions and validate them. On some blockchains, master nodes may have voting rights for proposals of modifications to the consensus algorithm. Light nodes or “lightweight nodes” depend on full nodes to function. Light nodes only download the block headers, storing and providing just the necessary data. They provide simplified payment verification (SPV), enabling faster transactions. Special nodes carry out special tasks such as implementing protocol changes or maintaining the protocols

The basic functions of blockchain nodes may be summarized By four primary functions. These functions are that a node is configured for (a) accepting or rejecting transactions made on the blockchain, (b) checking transaction/data validity, (c) storing all data in cryptographically linked blocks, and (d) communicating with the other nodes in the network. Thus, nodes are a vital component of the blockchain, as nodes allow a ledger to be decentralized so as to ensure the integrity of the data. Without nodes, there would be no block and no chain.

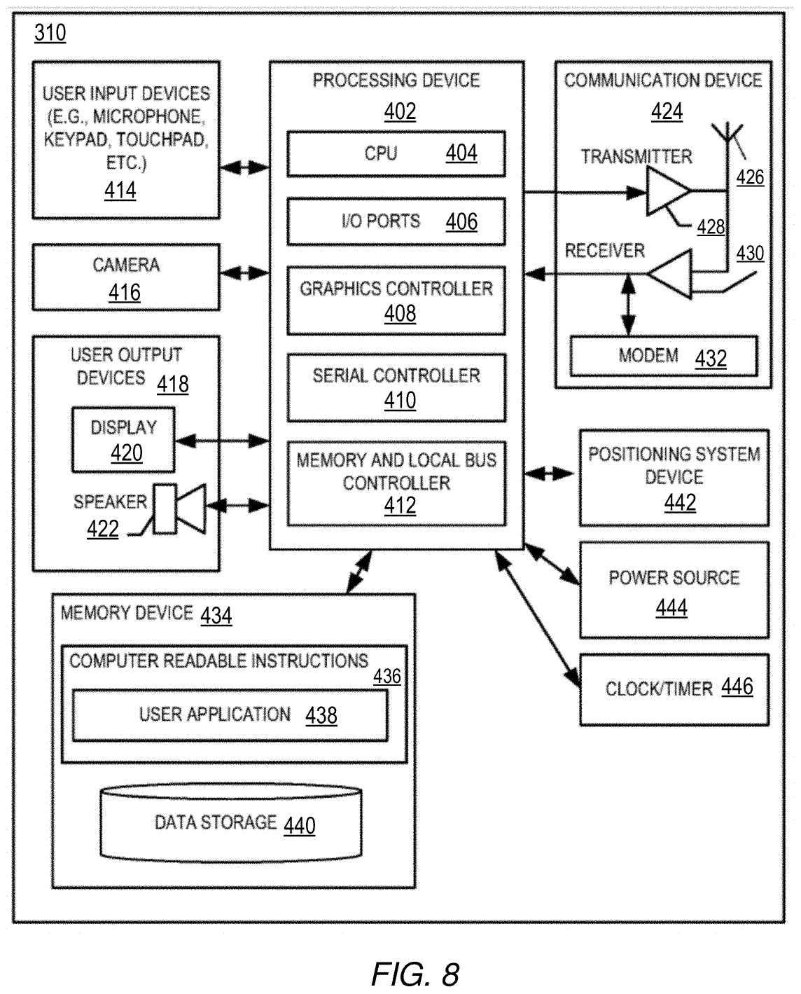

FIG. 9 is a simplified block diagram to illustrate a generic computer system to power the blockchain within the generic blockchain network environment of FIG. 7 according to the example embodiments. The computer-implemented blockchain system 330 may include a communication device 502, a processing device 504, and a memory device 506, each coupled together. The term “processing device” generally may include circuitry used for implementing the communication and/or logic functions of the particular system 330. For example, processing device 504 may include a digital signal processor device, a microprocessor device, various analog-to-digital converters, various digital-to-analog converters, and other support circuits and/or combinations of the foregoing. Control and signal processing functions of the blockchain system 330 allocated between these processing devices 504 according to their respective capabilities. Processing device 504 may include functionality to operate one or more software programs based on computer-readable instructions thereof, which may be stored in memory device 506.

Processing device 504 uses communication device 502 to communicate with network 301 and the other components in the network 301 as shown in FIG. 7. In an example, the communication device 502 generally comprises a modem, server, or other device for communicating with the other components shown in network 301.

System 330 additionally includes computer-readable instructions 510 stored in the memory device 506, which may be computer-readable instructions 510 of a blockchain application 512. In some embodiments, the memory device 506 includes data storage 508 for storing data related to the blockchain system 330 environment, but not limited to data created and/or used by the blockchain application 512.

In an example, memory device 306 stores the blockchain application 512 and a distributed ledger 514. Distributed lodger 514 may store data including, but not limited to, one or more portions of a transaction record. Each of the blockchain application 512 and distributed ledger 514 may associate with applications having computer-executable program code that instructs processing device 504 to operate communication device 302 to perform certain communications described herein. Additionally, the computer-executable program code of another application associated with distributed ledger 514 and blockchain application 512 could direct processing device 304 to perform certain logic, data processing, and data storing functions rtf this other application.

Accordingly, processing device 504 is configured to use communication device 502 to gather data (data corresponding to transactions, blocks or other updates to the distributed ledger 514) from various disparate off-block data sources such as the Internet, other networks, and other blockchain network systems. The data received by processing device 504 is stored in its copy of the distributed ledger 514, which in turn is stored in memory device 506.

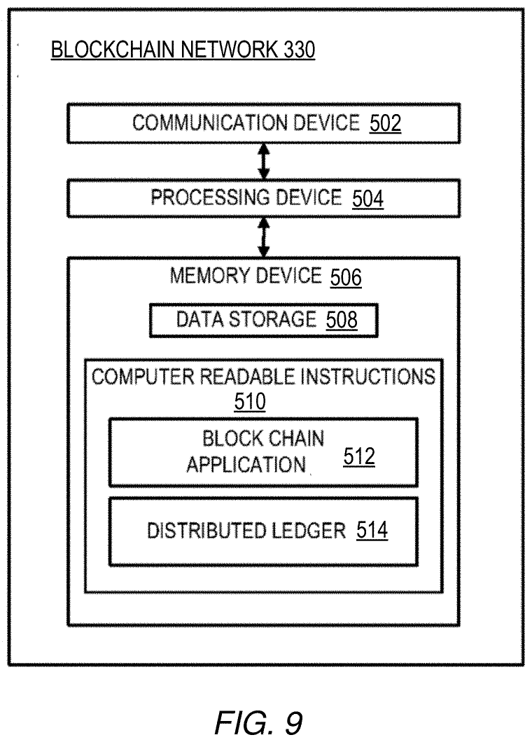

FIG. 10 is a simplified high level block diagram to illustrate a generic centralized database architecture environment for the network of FIG. 7, according to the example embodiments. Centralized database architecture 600 includes multiple nodes 320 from one or more external data sources and which converge into a centralized database. The system, in this embodiment, may generate a single centralized ledger for data received from the various nodes 320.

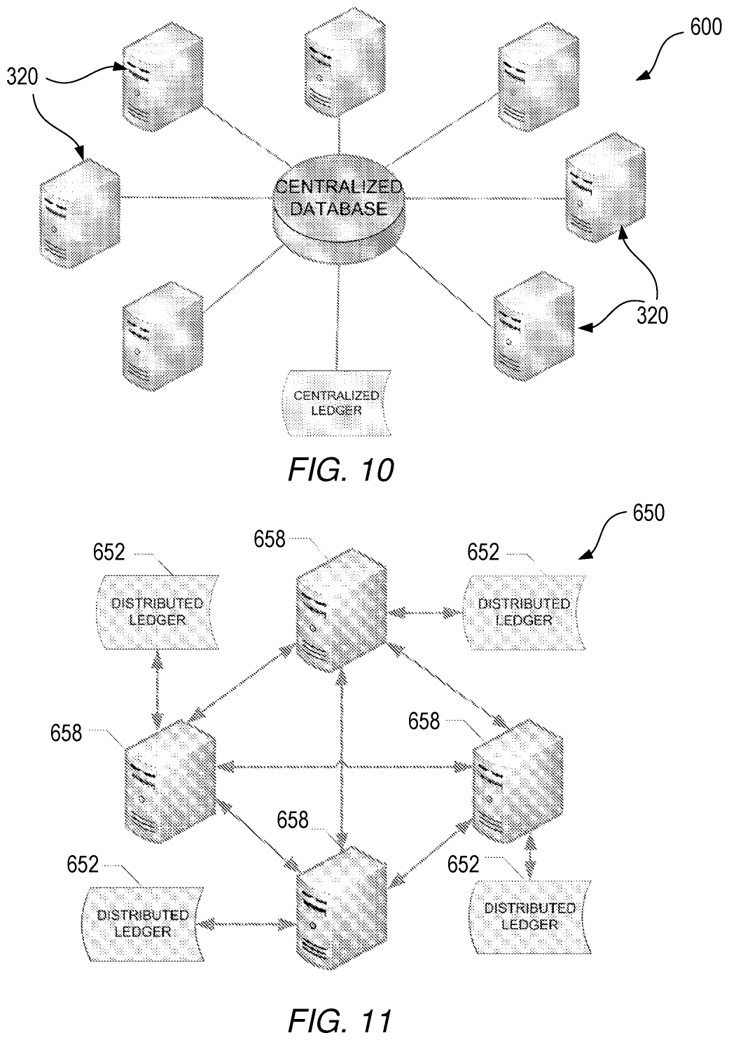

FIG. 11 is a simplified high level block diagram to illustrate a generic blockchain system environment architecture of the system in FIG. 9, according to the example embodiments. FIG. 11 shows a blockchain environment architecture 650. Rather than utilizing a centralized database architecture 600 of data for instrument conversion, as shown in FIG. 10, various embodiments could use a decentralized blockchain configuration having the blockchain environment architecture 650 as shown in FIG. 11.

A blockchain system such as system 330 typically has two primary types of data records. The first type is the transaction type, which consists of the actual data stored in the block chain. The second type is the block type, which are records that confirm when and in what sequence certain transactions became recorded as part of the blockchain. Transactions are created by participants using the blockchain in the normal course of business, for example, when someone sends cryptocurrency to another person, and blocks are created by individuals known as “miners” (as previously described) who use specialized software/equipment to create blocks. If the blockchain system 330 is a closed system closed, the number of miners are known and the system 330 comprises primary sponsors that generate and create the new blocks therein. As such, any block may be worked on by a primary sponsor.

Users 302 of the blockchain create transactions that are passed around to various nodes 320 of the blockchain. A “valid” transaction is one that can be validated based on a set of rules that are defined by the particular system implementing the block chain. For example, in the case of cryptocurrencies, a valid transaction is one that is digitally signed, spent from a valid digital wallet and, in some cases that meets other criteria.

As mentioned above and referring to FIG. 11, a blockchain 650 typically employs a distributed ledger 652 (I.e., a decentralized ledger). This is maintained on multiple nodes 658 of the block chain 650, One node 658 in the blockchain 650 may have a complete or partial copy of the entire ledger 652, or a set of transactions and/or blocks on the blockchain 650. Transactions are initiated at a node 658 of the blockchain 650 and communicated to the various other nodes 658, Any of the nodes 658 can validate a transaction, add the transaction to its copy of the blockchain 650, and/or broadcast the transaction, its validation in the form of a block) and/or other data to other nodes 658. This other data may include time-stamping, such as is used in cryptocurrency blockchains. In some embodiments, the nodes 658 might be heal theme or health insurance institutions that function as gateways for other healthcare or health insurance institutions.

The example methodology shows how DSCs, foundational expressions of the encapsulation paradigm, can provide an enabling if not mirrored substrate for the blockchain and other distributed technologies. Through the properties of independence, plasticity, uniformity, hierarchy, security, portability, and congruity, DSCs can provide a flexible but immutable template for blockchain operations. Moreover, the use of encapsulation to create DSCs from external disparate database records may offer needed flexibility to the blockchain by allowing expansion thereof while maintaining its immutability.

The example method may provide even further advantages and benefits. The ability to have unfettered access to all company data in an organized, searchable format thus enables better business decisions to be made based on the information available, thereby enhancing the ability to extract more actionable and relevant information. Also, Applicant's method may provide for substantial cost savings as a further benefit.

The present invention, in its various embodiments, configurations, and aspects, includes components, methods, processes, systems and/or apparatuses substantially as depicted and described herein, including various embodiments, sub-combinations, and subsets thereof. Those of skill in the art will understand how to make and use the present invention after understanding the present disclosure.

The present invention, in its various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

I claim:

1. A method of creating a distributed ledger for a blockchain via encapsulation of off-chain data, the off-chain data represented as one or more data records having differently structured and unstructured formats, the data records ingested from multiple different and disparate data storage locations external to the blockchain, comprising:
creating, via encapsulation, a plurality of field-value pairs representative of the given external data record of off-chain data, the plurality of field-value pairs being created dynamically without regard to the underlying data structure of the given external data record of off-chain data, and
adding the created plurality of field-value pairs as blockchain transactions to a body portion of each of one or more blocks across the blockchain.

2. The method of claim 1, wherein any new data added externally into the given external data record of off-chain data at its given storage location external to the blockchain is also added dynamically as blockchain transactions to the body portion of each block across the blockchain.

3. The method of claim 1, wherein the plurality of field-value pairs created through encapsulation represent a distributed ledger by which data can be added as blockchain transactions across all blocks of the blockchain.

4. The method of claim 1, wherein infinite external data records of off-chain data at infinite length are adapted to be added on the fly with their associated record identifications as blockchain transactions without having to define any of the data record structure beforehand.

5. The method of claim 1, wherein the ingestion further includes ingesting files containing additional external data records, the files residing in multiple data storage locations other than the given storage location external to the blockchain in which the given external data record of off-chain data is stored.

6. The method of claim 1, wherein encapsulation includes:
separating the ingested given external data record of off-chain data into a plurality of tuples,
splitting out a data part and a fieldname part from each tuple,
creating a pointer by combining the fieldname part, a record identifier of the given external data record of off-chain data, and a database identifier of its given storage location,
appending the created pointer to the data part to form a field-value pair, each formed field-value pair having the same structure and each formed field-value pair representing encapsulated data of the given external data record, and
storing each field-value pair in a single data store.

7. The method of claim 6, wherein
the steps of separating, splitting, creating, and appending are executed by object-based programming functions adapted to both encapsulate and de-encapsulate the ingested given external data record of off-chain data, and
the object-based programming functions both create the field-value pairs and reform the originally ingested given external data record of off-chain data from the field-value pairs.

8. The method of claim 6, wherein an application programing interface (API) is provided for create the plurality of field-value pairs, the API including calls for both saving and retrieving the ingested given external data record of off-chain data, inclusive of steps which perform separating, splitting, creating, and appending functionality to encapsulate and de-encapsulate the ingested given external data record of off-chain data.

9. The method of claim 6, wherein each stored field-value pair is freely searchable irrespective of the original structured or unstructured format of its underlying data record, and irrespective of the data storage location from which the data record was ingested, the stored field-value pairs co-existing without any structural barriers between them in the single data store.
